(19) United States
(12) Patent Application Publication
(10) Pub. No.: US 2025/0273884 A1
(43) Pub. Date: Aug. 28, 2025

(54) Interconnection System with Electromagnetic Absorber with Improved Performance

(71) Applicant: TE Connectivity Solutions GmbH, Schaffhausen (CH)

(72) Inventors: Bruce Allen CHAMPION, Camp Hill, PA (US); Scott Eric WALTON, Mount Joy, PA (US); Charles Raymond GINGRICH, III, Mechanicsburg, PA (US)

(73) Assignee: TE Connectivity Solutions GmbH, Schaffhausen (CH)

(21) Appl. No.: 18/589,496

(22) Filed: Feb. 28, 2024

(51) Int. Cl. H01R 12/52; H01R 13/6586; H05K 1/14

(52) U.S. Cl. CPC H01R 12/52; H01R 13/6586; H05K 1/141; H05K 2201/10189

(57) ABSTRACT

An electrical interconnection system. The electrical interconnection system includes a housing with at least one circuit board positioned in the housing. At least one cavity is positioned proximate the at least one circuit board. At least one electromagnetic absorber member is positioned in the at least one cavity. The at least one electromagnetic absorber member reduces resonance present in the at least one cavity.

### FIELD OF THE INVENTION

The invention relates to an interconnection system which has reduced cavity resonance. In particular, the invention is directed to an interconnection system or connector which has an electromagnetic absorber positioned between circuit boards to reduce the cavity resonance.

### BACKGROUND OF THE INVENTION

Interconnection systems or connectors are used to route signals from one electronic component to another. Because of the complexity of devices, the interconnection systems are often required to carry much data. Furthermore, this data is generally transmitted at a high data rate. There is simultaneously a need to make the systems as small as possible. As a result, there is a need to have interconnection systems that can carry many high speed signals in a relatively small space. There is thus a need for high speed, high density connectors.

One of the difficulties that results when a high density, high speed connector is used is that the circuit boards can be so close that there can be electrical interference between adjacent or nearby circuit boards. To reduce interference, and to otherwise provide desirable electrical properties, metal members or shields are often placed between or around adjacent circuit boards. The metal acts as a shield to prevent signals carried on one signal conductor of one circuit board from creating “cross talk” on another signal conductor of another circuit board. The metal also impacts the impedance of each conductor, which can further contribute to desirable electrical properties.

While the shielding and the circuit boards contributes to desirable electrical properties, the shielding can contribute to increased resonance in the spaces or cavities between the circuit boards. Such resonance can hinder the performance of the circuit board and the connector, and ultimately the performance of the device.

It would therefore be beneficial to provide an interconnection system or connector which reduces the cavity resonance. In particular, it would be beneficial to provide an electromagnetic absorber between adjacent circuit boards to reduce the resonance in the cavities between the circuit boards, thereby enhancing the overall performance of the interconnection system or connector.

### SUMMARY OF THE INVENTION

The following provides a summary of certain illustrative embodiments of the present invention. This summary is not an extensive overview and is not intended to identify key or critical aspects or elements of the present invention or to delineate its scope.

An embodiment is directed to an electrical interconnection system. The electrical interconnection system includes a housing having a mating end and a mounting end. A plurality or circuit boards extend between the mating end and the mounting end of the housing. A plurality of cavities are provided between the plurality of circuit boards. Electromagnetic absorber members are provided in the plurality of cavities. The electromagnetic absorber members reduce resonance present in the plurality of cavities.

An embodiment is directed to an electrical interconnection system. The electrical interconnection system includes a housing with at least one circuit board positioned in the housing. At least one cavity is positioned proximate the at least one circuit board. At least one electromagnetic absorber member is positioned in the at least one cavity. The at least one electromagnetic absorber member reduces resonance present in the at least one cavity.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

FIG. 1 is a perspective view of an illustrative embodiment of an interconnection system or connector according the present invention, the interconnection system or connector having electromagnetic absorbing material provided between circuit boards.

FIG. 2 is a perspective view of on illustrative electromagnetic absorber of FIG. 1.

FIG. 3 is a cross-section view taken along line 3-3 of FIG. 1.

FIG. 4 is a cross-section view taken along line 4-4 of FIG. 1.

FIG. 5 is a cross-section view taken along line 5-5 of FIG. 1.

FIG. 6 is a cross-section view taken along line 6-6 of FIG. 1.

FIG. 7 is a cross-section view taken along line 7-7 of FIG. 1.

FIG. 8 is a graph near end cross-talk versus frequency for the interconnection system or connector shown in FIG. 1.

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

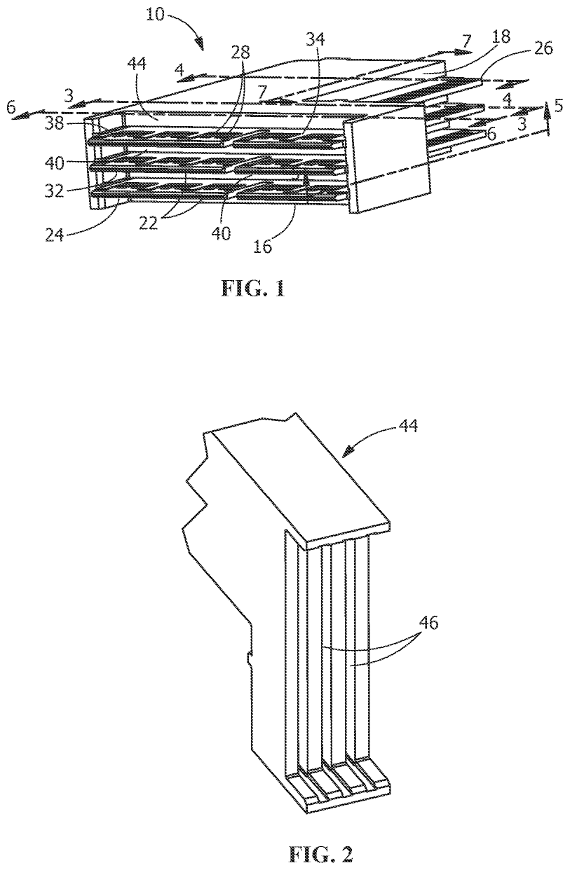

FIG. 1 illustrates an electrical connector assembly 10 formed in accordance with an illustrative embodiment. In the illustrative embodiment, the electrical connector assembly 10 is a daughtercard connector that can be mated to a mating backplane connector (not shown) to electrically connect a backplane circuit board (not shown) and a daughtercard circuit board (not shown). While the electrical connector assembly 10 is described herein with reference to a daughtercard connector, it is realized that the subject matter herein may be utilized with different types of electrical connectors other than a daughtercard connector. The daughtercard connector assembly 10 is merely illustrative of an illustrative embodiment of the type of electrical connector assembly 10 that mates with a mating connector.

In the illustrative embodiment shown, the connector assembly 10 constitutes a right angle connector wherein a mating end 16 and mounting end 18 of the connector assembly 10 are oriented perpendicular to one another. The connector assembly 10 is mounted to the daughtercard circuit board (not shown) at the mounting end 18. The connector assembly 10 is mounted to the mating connector (not shown) at the mating end 16. Other orientations of the ends 16, 18 are possible in alternative embodiments.

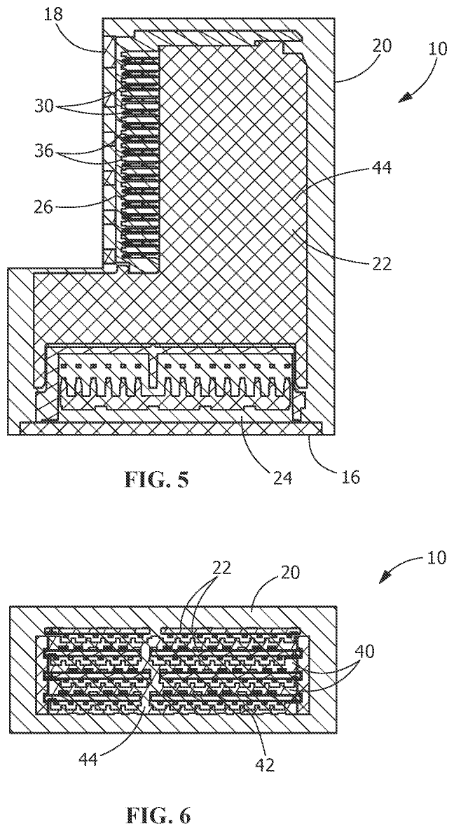

As shown in the illustrative embodiment shown in FIGS. 1 through 7, the connector assembly 10 includes a housing 20 with a plurality of substrates or circuit boards 22 retained in the housing. The substrates or circuit boards 22 extend through the housing 20 from the mating end 16 to the mounting end 18. In the illustrative embodiment shown, the connector assembly 10 has four circuit boards 22, but other numbers of circuit boards 22 may be provided. The circuit boards 22 extend in planes which are parallel and spaced from adjacent circuit boards 22.

Each of the circuit boards 22 has a mating end 24 configured to mate with the mating connector (not shown) and a mounting end 26 which is configured to mount to the daughtercard circuit board (not shown). The mating ends 24 extend from the mating end 16 of the connector assembly 10 and the mounting ends 26 extend from the mounting end 18 of the connector assembly 10. Each circuit board 22 has a plurality of individual signal pathways which include mating signal contact pads 28, signal traces (not shown) and mounting signal contacts 30. The mating signal contact pads 28 are mechanically and electrically connected to the signal traces by known methods. The mounting signal contacts 30 are mechanically and electrically connected to the signal traces by known methods, such as but not limited to soldering. The signal pathways extend from proximate the mating end 24 to the mounting end 26. In the illustrative embodiment shown, the individual signal pathways are positioned on a first surface 32 of the circuit boards 22. However, in other embodiments, the signal pathways may be internal to the circuit boards 22.

Each circuit board 22 has a plurality of first ground pathways which include mating ground contact pads 34, ground traces (not shown) and mounting ground contacts 36. The mating ground contact pads 34 are mechanically and electrically connected to the signal traces by known methods. The mounting ground contacts 36 are mechanically and electrically connected to the ground traces by known methods, such as but not limited to soldering. The ground pathways extend from proximate the mating end 24 to the mounting end 26.

In the illustrative embodiment shown, each of the circuit boards 22 include second ground plane or traces on a second surface 38. The second surface 38 being opposed and spaced from the first surface 32. The ground plane or traces extend from proximate the mating end 24 to the mounting end 26.

Cavities or slots 40 are provided between the circuit boards 22. The cavities or slots 40 extend from a first surface 32 of a respective circuit board 22 to a second surface 38 of an adjacent circuit board 22 or from a first surface 32 of a respective circuit board 22 to a wall 42 of the housing 20.

In the illustrative embodiment, an electromagnetic absorber member 44 is provided in each of the cavities or slots 40. However, in other embodiments, the electromagnetic absorber member 44 may not be required to be positioned in every cavity or slot 40. For example, the electromagnetic absorber member 44 may be positioned in every other cavity or slot 40 and still have the performance characteristics required for the particular application. In another embodiment, the electromagnetic absorber member 44 may only be positioned in the cavities or slots 40 of the connector assembly 10 positioned proximate to the circuit boards 22 which accommodate high speed signals.

The electromagnetic absorber members 44 are positioned to reduce the resonance present in the cavities or slots 40. The electromagnetic absorber members 44 also improve crosstalk and overall connector performance. The electromagnetic absorber members 44 can be comprised of either high dielectric loss material or high magnetic loss material and is provided to absorb the unwanted electromagnetic energy which is present in the cavities or slots 40.

The electromagnetic absorber members 44 may be made of a thermoplastic or other suitable binder material such that electromagnetic absorber members 44 may be molded around the circuit boards 22 or particular portions of the circuit boards 22. The electromagnetic absorber members 44 contain particles which provide the desirable electromagnetic properties.

The electromagnetic absorber member 44 may be formed from material with a controlled conductivity. Controlled conductivity is generated from a base material loaded with a filler material, that when combined, create a composite material with a conductivity higher than the base material. The selected filler can create a dielectric or magnetic absorber. A high dielectric loss material with a dielectric loss tangent between 0.2 and 1 or a high magnetic loss material with a magnetic loss tangent between 0.2 and 2 over the frequency range of interest, i.e. a frequency range of 1 GHz to 40 GHZ, would be considered an electromagnetic absorber in this embodiment.

The materials may be formed from materials that are generally thought of as conductors, but are either relatively poor conductors over the frequency range of interest, contain particles or regions that are sufficiently dispersed that they do not provide high conductivity or otherwise are prepared with properties that lead to a relatively weak bulk conductivity over the frequency range of interest.

In some illustrative embodiments, the material is formed by adding a filler that contains conductive particles to a binder. Examples of conductive particles that may be used as a filler to form an electrically lossy materials include carbon or graphite formed as fibers, flakes or other particles. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

In various alternate illustrative embodiments, the electromagnetic absorber members 44 may be formed from material traditionally regarded as magnetic materials. In these embodiments, the electromagnetic absorber members 44 may be formed of a binder material with fillers. The binder may be the same as the binder used described above or any other suitable binder. The binder is filled with magnetic particles, such as, but not limited to flakes or fibers. Materials such as, but not limited to, magnesium ferrite, nickel ferrite, lithium ferrite, yttrium garnet or aluminum garnet may be used. Preferred ferrite materials, when combined with a base material, have a magnetic loss tangent greater than 0.3 in the frequency range of interest.

The binder or base, for use with either the dielectric material or the magnetic material, may be any material that will set, cure or can otherwise be used to position the electromagnetic absorber members 44. Examples of the binder or base, include, but are not limited to, moldable, epoxy, foam or silicone based material. In some embodiments, the binder may be a thermoplastic material such as is traditionally used in the manufacture of electrical connectors to facilitate the molding of the electromagnetic absorber members 44 into the desired shapes and locations as part of the manufacture of the electrical connector assembly 10. However, many alternative forms of binder materials may be used. Curable materials, such as epoxies, can serve as a binder. Alternatively, materials such as thermosetting resins or adhesives may be used. In other illustrative embodiments, conducting particles may be impregnated into a formed binder material. As used herein, the term “binder” encompasses a material that encapsulates the filler or is impregnated with the filler.

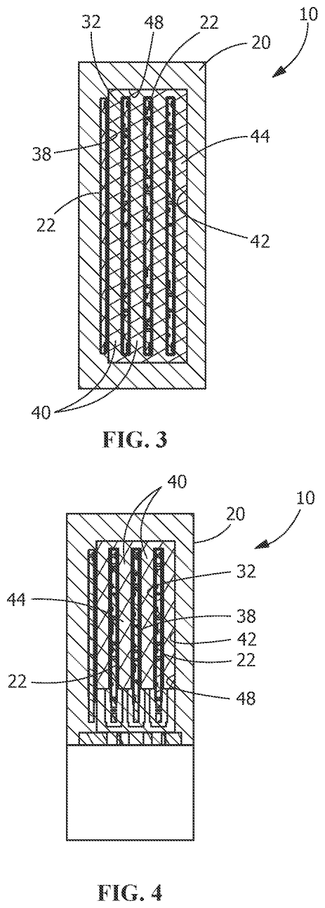

In the illustrative embodiment shown in the FIGS. 1 through 7, the electromagnetic absorber member 44 is molded in one piece, as shown in FIG. 2. The electromagnetic absorber member 44 has slots 46 which are dimensioned to receive the circuit boards 22 therein. The electromagnetic absorber member 44 is dimensioned to be received in the circuit board receiving area or opening 48 of the housing 20 of the electrical connector assembly 10 and extend from the mating end 16 the mounting end 18. In this illustrative embodiment, the electromagnetic absorber member 44 is configured to surround each circuit board 22, as shown in FIG. 3.

In other illustrative embodiments, the electromagnetic absorber members 44 may include individual members provided in each of the cavities or slots 40 provided between the circuit boards 22. The individual members may span the entire area of the circuit boards 22 or the individual members may be positioned in only the areas of the circuit board 22 in which components or traces on the circuit boards require unwanted electromagnetic energy to be absorbed to reduce the cavity resonance and improve the crosstalk, for example at the mating end 24 and the mounting end 26 of the circuit board 22. In these embodiments, the electromagnetic absorber members 44 may not completely surround the circuit boards 22 or portions thereof.

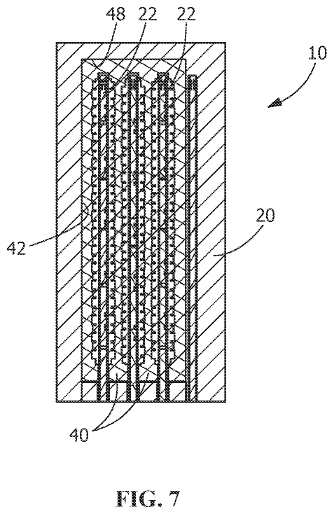

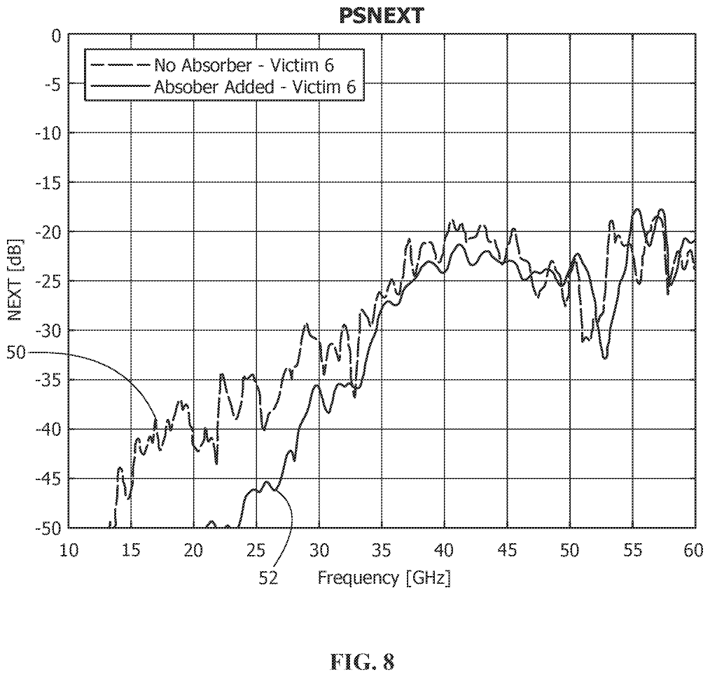

The electromagnetic absorber members 44 may be spaced from the first surfaces 32 and the second surfaces 38 of the circuit boards 22, as shown in FIG. 7. Alternatively, the electromagnetic absorber members 44 may be spaced from the first surfaces 32 and touch or engage the second surfaces 38 of the circuit boards 22; the electromagnetic absorber members 44 may touch or engage the first surfaces 32 and be spaced from the second surfaces 38 of the circuit boards 22; or the electromagnetic absorber members 44 may touch or engage the first surfaces 32 and touch or engage the second surfaces 38 of the circuit boards 22.

FIG. 8 illustrates improvement in near end crosstalk (NEXT) for various frequencies of the illustrative connector assembly shown in the figures. The power sum near end crosstalk (PSNEXT) is graphed for a connector assembly with no electromagnetic absorber members positioned in the cavities, line 50, and for the connector assembly 10 with the electromagnetic absorber member 44 positioned in the cavities or slots 40 as shown, line 52.

While the electromagnetic absorber members 44 are shown in connection with a daughter card connector assembly 10, the benefits of using such electromagnetic absorber members 44 is not limited to use in such daughter card connector assemblies 10. Such electromagnetic absorber members 44 may be used in other types of connectors and may be applied in connectors other than board to board connectors.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. An electrical interconnection system comprising:
a housing having a mating end and a mounting end;
a plurality or circuit boards extending between the mating end and the mounting end of the housing;
a plurality of cavities provided between the plurality of circuit boards;
electromagnetic absorber members provided in the plurality of cavities;
wherein the electromagnetic absorber members reduce resonance present in the plurality of cavities.

2. The electrical interconnection system as recited in claim 1, wherein the plurality of circuit boards are retained in a housing.

3. The electrical interconnection system as recited in claim 1, wherein the electromagnetic absorber members include a high dielectric loss material.

4. The electrical interconnection system as recited in claim 1, wherein the electromagnetic absorber members include a high magnetic loss material.

5. The electrical interconnection system as recited in claim 1, wherein the electromagnetic absorber members extend from the mating end of the housing to the mounting end of the housing.

6. The electrical interconnection system as recited in claim 1, wherein the electromagnetic absorber members are provided proximate mating ends of the plurality of circuit boards and mounting ends of the plurality of circuit boards.

7. The electrical interconnection system as recited in claim 1, wherein the electromagnetic absorber members have a dielectric loss tangent between 0.2 and 1 or a magnetic loss tangent between 0.2 and 2 in the frequency range of 1 GHz to 40 GHz.

8. The electrical interconnection system as recited in claim 1, wherein the plurality of circuit boards have first surfaces and second surfaces the electromagnetic absorber members are spaced from one or both of the first surfaces and the second surfaces.

9. The electrical interconnection system as recited in claim 1, wherein the plurality of circuit boards have first surfaces and second surfaces the electromagnetic absorber members are engage both of the first surfaces and the second surfaces.

10. An electrical interconnection system comprising:
a housing;
at least one circuit board positioned in the housing;
at least one cavity positioned proximate the at least one circuit board;
at least one electromagnetic absorber member positioned in the at least one cavity;
wherein the at least one electromagnetic absorber member reduces resonance present in the at least one cavity.

11. The electrical interconnection system as recited in claim 10, wherein the at least one electromagnetic absorber member include a high dielectric loss material.

12. The electrical interconnection system as recited in claim 10, wherein the at least one electromagnetic absorber member include a high magnetic loss material.

13. The electrical interconnection system as recited in claim 10, wherein the at least one circuit board is a plurality or circuit boards and the at one cavity is a plurality of cavities, each cavity of the plurality of cavities is positioned proximate a respective circuit board of the plurality of circuit boards.

14. The electrical interconnection system as recited in claim 13, wherein an electromagnetic absorber member of the at least one electromagnetic absorber member is provided in each of the plurality of cavities.

15. The electrical interconnection system as recited in claim 14, wherein each circuit board of the plurality of circuit boards has a first surface and a second surface, electromagnetic absorber members of the at least one electromagnetic absorber member are spaced from one or both of the first surfaces and the second surfaces.

16. The electrical interconnection system as recited in claim 14, wherein each circuit board of the plurality of circuit boards has a first surface and a second surface, electromagnetic absorber members of the at least one electromagnetic absorber member engage the first surfaces and the second surfaces.

17. The electrical interconnection system as recited in claim 10, wherein the at least one circuit board has first contact pads positioned on a mating end thereof and second contact pads positioned on a mounting end thereof.

18. The electrical interconnection system as recited in claim 17, wherein the at least one electromagnetic absorber member extends from proximate the mating end of the at least one circuit board to proximate the mounting end of the at least one circuit board.

19. The electrical interconnection system as recited in claim 17, wherein the at least one electromagnetic absorber member is provided proximate the mating end of the at least one circuit board and the mounting end of the at least one circuit board.

20. The electrical interconnection system as recited in claim 10, wherein the electromagnetic absorber members have a dielectric loss tangent between 0.2 and 1 or a magnetic loss tangent between 0.2 and 2 in the frequency range of 1 GHz to 40 GHz.
